(19) United States
(12) Patent Application Publication
(10) Pub. No.: US 2015/0367607 A1
(43) Pub. Date: Dec. 24, 2015

(54) METHODS OF FORMING STRENGTHENED SINTERED GLASS STRUCTURES

(71) Applicant: CORNING INCORPORATED, Corning, NY (US)

(72) Inventor: Sean Matthew Garner, Elmira, NY (US)

(21) Appl. No.: 14/768,118

(22) PCT Filed: Feb. 13, 2014
(86) PCT No.: PCT/US2014/016223

§ 371 Date: Aug. 14, 2015

Related U.S. Application Data
(60) Provisional application No. 61/767,382, filed on Feb. 21, 2013.

(51) Int. Cl. B32B 17/06; C03C 27/04; C03C 17/04

(52) U.S. Cl. CPC B32B 17/06; C03C 17/04; C03C 27/044; C03C 2218/17; C03C 2218/32

(57) ABSTRACT

A strengthened layered glass structure includes a first substrate layer comprising a flexible glass sheet having a thickness of less than or equal to 300 μm, a second substrate layer, and a sintered glass frit material layer coupled to a first surface of the first substrate layer and a second surface of the second substrate layer, the sintered glass frit material layer comprising a sintered glass frit coupled to the first and second surfaces providing the flexible glass sheet with a compressive stress of at least about 100 MPa across a thickness of the flexible glass sheet.

This application claims the benefit of priority of U.S. Provisional Application Ser. No. 61/767,382 filed on Feb. 21, 2013 the content of which is relied upon and incorporated herein by reference in its entirety.

### FIELD

The present disclosure relates to layered glass structures and, more particularly, to strengthened/damage and impact resistant glass layered structures.

### BACKGROUND

Layered glass structures may be used as components in the fabrication of various appliances, automobile components, architectural structures or electronic devices. For example, layered glass structures may be incorporated as cover glass for various end products such as refrigerators, decorative glazing, televisions, or as embedded touch laminates for smart interactive displays. However, applications that utilize layered glass structures are subject to strength and impact resistance limitations. Additionally, some electronics require specially shaped layered glass structures, such as layered glass sheets with curved, shaped, beveled, bezeled, or otherwise contoured profiles. Accordingly, there is a need for apparatuses and methods for forming strengthened and/or impact resistant layered glass structures.

### SUMMARY

One technique to improve the mechanical reliability and impact resistance of flexible glass is to position a layer of a sintered material between two sheets of flexible glass, or between a sheet of flexible glass and another substrate. Flexible glass may be glass having a thickness of 300 microns or less, including but not limited to, 300, 275, 250, 225, 200, 190, 180, 170, 160, 150, 140, 130, 120, 110, 100, 90, 80, 70, 60, 50, 40, 30, 20, or 10 microns. Depending on the mechanical strength and impact resistance requirements of a layered glass structure, as well as the expected bending stresses and purpose of the layered glass structure within the intended application, a layered glass structure can be designed to meet various mechanical requirements according to the concepts disclosed herein. When used properly, the layered glass structures can offer improved mechanical reliability and impact resistance performance over unlayered flexible glass. For example, impact resistance of a layered glass structure may be defined by performance in a ball drop test or by a compressive stress analysis.

Additional features and advantages will be set forth in the detailed description which follows, and in part will be readily apparent to those skilled in the art from the description or recognized by practicing the disclosure as exemplified in the written description and the appended drawings. It is to be understood that both the foregoing general description and the following detailed description are merely exemplary of the disclosure, and are intended to provide an overview or framework to understanding the nature and character of the disclosure as it is claimed.

The accompanying drawings are included to provide a further understanding of principles of the disclosure, and are incorporated in and constitute a part of this specification. The drawings illustrate one or more embodiment(s), and together with the description serve to explain, by way of example, principles and operation of the disclosure. It is to be understood that various features of the disclosure disclosed in this specification and in the drawings can be used in any and all combinations. By way of non-limiting example the various features of the disclosure may be combined with one another according to the following aspects.

According to a first aspect, there is provided a strengthened layered glass structure comprising:

a first substrate layer comprising a flexible glass sheet having a thickness of ≦300 μm;

a second substrate layer; and

a sintered glass frit material layer coupled to a first surface of the first substrate layer and a second surface of the second substrate layer, the sintered glass frit material layer comprising a sintered glass frit coupled to the first and second surfaces providing the flexible glass sheet with a compressive stress of at least about 100 MPa across a thickness of the flexible glass sheet.

According to a second aspect, there is provided the strengthened layered glass structure of aspect 1, wherein the flexible glass sheet has a thickness of ≦200 μm.

According to a third aspect, there is provided the strengthened layered glass structure of aspect 1, wherein the flexible glass sheet has a thickness of ≦100 μm.

According to a fourth aspect, there is provided the strengthened layered glass structure of any one of aspects 1 through 3, wherein the second substrate layer is comprised of one of copper, metal, glass, or a metal alloy.

According to a fifth aspect, there is provided the strengthened layered glass structure of any one of aspects 1 through 4, wherein a thickness of the sintered glass frit material layer is from 25 μm to 125 μm.

According to a sixth aspect, there is provided the strengthened layered glass structure of any one of aspects 1 through 5, wherein the flexible glass sheet is a chemically strengthened glass sheet.

According to a seventh aspect, there is provided the strengthened layered glass structure of any one of aspects 1 through 6, wherein the strengthened layered glass structure is subjected to an ion exchange process.

According to an eighth aspect, there is provided the strengthened layered glass structure of any one of aspects 1 through 7, wherein a thickness of strengthened layered glass structure is less than or equal to 300 μm.

According to a ninth aspect, there is provided the strengthened layered glass structure of any one of aspects 1 through 8, further comprising a second and a third sintered glass frit material layer.

According to a tenth aspect, there is provided the strengthened layered glass structure of any one of aspects 1 through 9, wherein the compressive stress is ≧180 MPa.

According to an eleventh aspect, there is provided the strengthened layered glass structure of any one of aspects 1 through 10, wherein the strengthened layered glass structure is subjected to an ion exchange process after lamination.

According to a twelfth aspect, there is provided a method of forming strengthened layered glass structures comprising:

providing a first substrate layer comprising a flexible glass sheet having a thickness of ≦300 μm;

applying a layer of glass frit material to a surface of the flexible glass sheet, forming a layered glass structure;

heating the glass frit material at a temperature sufficient for sintering the glass frit material such that upon cooling a compressive stress of at least 100 MPa is introduced across a thickness of the flexible glass sheet.

According to a thirteenth aspect, there is provided the method of forming strengthened layered glass structures of aspect 12, wherein the glass frit material is a glass frit tape.

According to a fourteenth aspect, there is provided the method of forming strengthened layered glass structures of any one of aspects 12 or 13 further comprising providing a second substrate layer to the layered glass structure.

According to a fifteenth aspect, there is provided the method of forming strengthened layered glass structures of aspect 14, wherein the second substrate layer is comprised of one of copper, metal, glass or a metal alloy.

According to a sixteenth aspect, there is provided the method of forming strengthened layered glass structures of any one of aspects 12 through 15, wherein the compressive stress is ≧180 MPa.

According to a seventeenth aspect, there is provided the method of forming strengthened layered glass structures of any one of aspects 12 through 16, wherein the flexible glass sheet has a thickness of ≦200 μm.

According to an eighteenth aspect, there is provided the method of forming strengthened layered glass structures of any one of aspects 12 through 17, wherein the glass frit material has a CTE that is ≧2 times a CTE of the flexible glass sheet.

According to a nineteenth aspect, there is provided the method of forming strengthened layered glass structures of any one of aspects 12 through 18, wherein a CTE value of the glass frit material is from 3 ppm/C to 10 ppm/C.

According to a twentieth aspect, there is provided the method of forming strengthened layered glass structures of any one of aspects 12 through 19, wherein a CTE value of the glass frit material is at least 3 ppm/C greater than a CTE value of the flexible glass sheet.

According to a twenty-first aspect, there is provided the method of forming strengthened layered glass structures of any one of aspects 12 through 20, wherein the glass frit material has a graded material composition.

According to a twenty-second aspect, there is provided the method of forming strengthened layered glass structures of any one of aspects 12 through 21, wherein the sintered glass frit material layer includes scattering elements or ultraviolet light absorption properties.

### BRIEF DESCRIPTION OF THE DRAWINGS

These and other features, aspects and advantages of the present disclosure are better understood when the following detailed description of the disclosure is read with reference to the accompanying drawings, in which:

FIGS. 1 and 2 depict cross-sectional views of one embodiment of a symmetric layered glass structure in accordance with aspects of the disclosure;

FIG. 3 depicts a cross-sectional view of one embodiment of an asymmetric layered glass structure in accordance with aspects of the disclosure;

FIGS. 4-6 depict cross-sectional views of different embodiments of layered glass structures with sintered glass frit material layers having graded compositions in accordance with aspects of the disclosure; and

FIG. 7 depicts a cross-sectional view of one embodiment of a symmetric layered glass structure with multiple sintered glass frit material layers in accordance with aspects of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Although glass is an inherently strong material, its strength and mechanical reliability is a function of its surface defect or flaw size density distribution and the cumulative exposure of stress to the material over time. During an entire product life cycle, a layered glass structure may be subjected to various kinds of static and dynamic mechanical stresses. Embodiments described herein generally relate to layered glass structures where a flexible glass sheet is strengthened using a frit material that is sintered to the flexible glass sheet. Particular examples discussed herein relate to layered glass structures where the frit material is a glass frit material. A relatively large coefficient of thermal expansion (CTE) mismatch between the glass frit material and the flexible glass sheet is utilized to improve the impact resistance of the layered glass structure by sintering the glass frit material to the flexible glass sheet at an elevated temperature followed by a slow cooling. Such an elevated temperature approach can create a nearly uniformly distributed compressive residual stress across the thickness of the flexible glass sheet once the layered glass structure is cooled.

### Strengthened Sintered Glass Structures

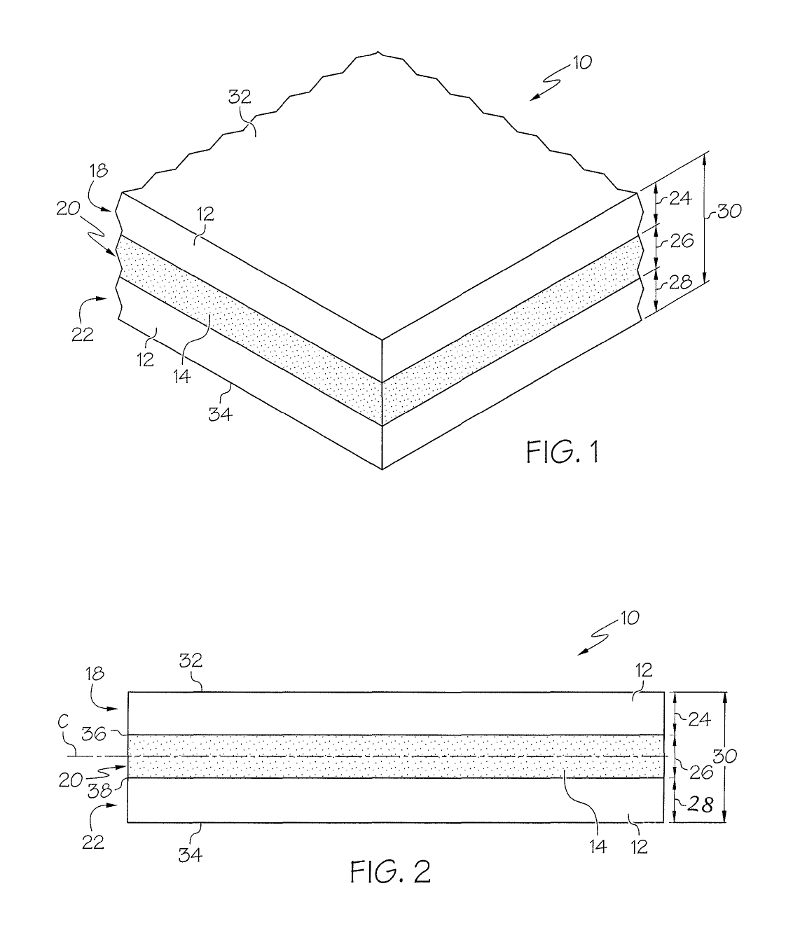

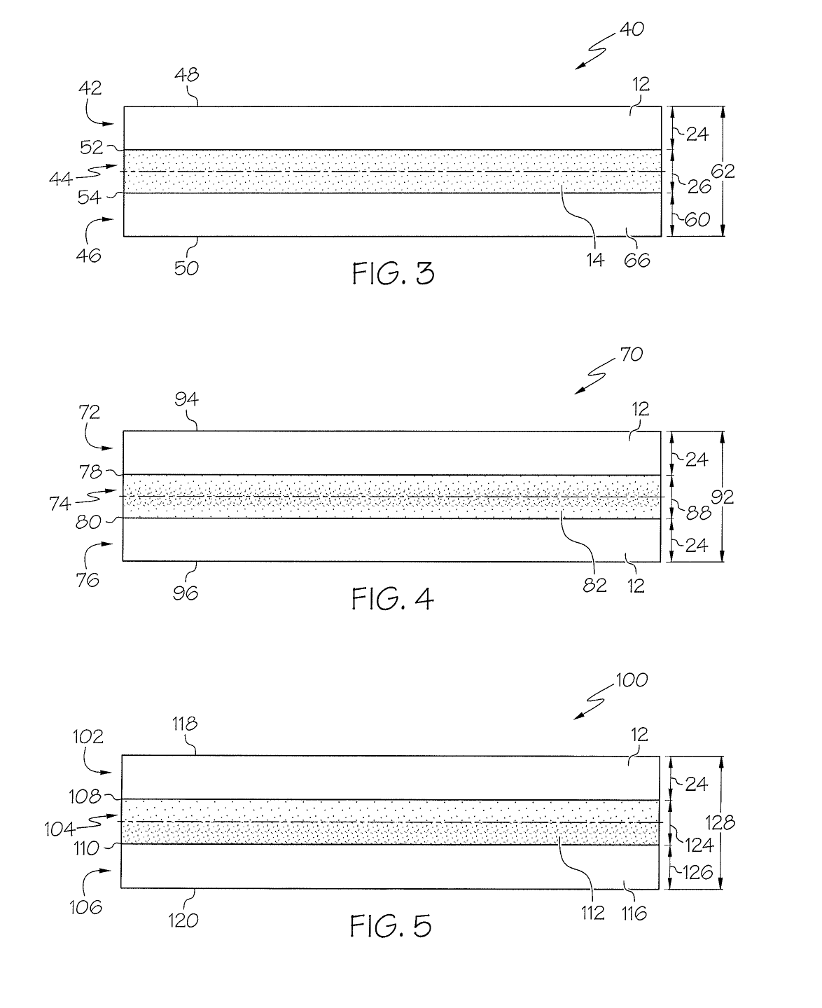

Referring to FIGS. 1, 2 and 3, cross-sectional views of exemplary strengthened sintered glass structures 10 and 40, also referred to herein as layered glass structures 10 and 40, are illustrated. Layered glass structures may be formed with flexible glass, frit materials (e.g., glass frit materials), and/or substrate materials (e.g., other than glass materials). Layered glass structures may also be symmetric or asymmetric. Symmetric layered glass structures, such as layered glass structure 10 shown in FIGS. 1 and 2, are formed such that the layers or partial layers below a central plane C of the layered glass structure form a mirror image of the layers or partial layers above the central plane C. Asymmetric layered glass structures, such as layered glass structure 40 shown in FIG. 3, do not have such a mirror image about the central plane C. Instead, asymmetric layered glass structures may include for example a flexible glass layer, a sintered frit material layer, and a substrate layer that may be a non-glass substrate or a non-identical glass, as discussed below.

In the layered glass structures described herein, the flexible glass may have a thickness of about 0.3 mm or less including but not limited to thicknesses of, for example, about 0.01-0.05 mm, about 0.05-0.1 mm, about 0.1-0.15 mm, about 0.15-0.3 mm, 0.3, 0.275, 0.25, 0.225, 0.2, 0.19, 0.18, 0.17, 0.16, 0.15, 0.14, 0.13, 0.12, 0.11, 0.10, 0.09, 0.08 0.07, 0.06, 0.05, 0.04, 0.03, 0.02, or 0.01 mm. The flexible glass may be formed of glass, a glass ceramic, a ceramic material or composites thereof. A fusion process (e.g., downdraw process) that forms high quality flexible glass can be used in a variety of devices such as flat panel displays. Glass produced in a fusion process has surfaces with superior flatness and smoothness when compared to glass produced by other methods. A fusion process is described in U.S. Pat. Nos. 3,338,696 and 3,682,609. Other suitable glass forming methods include a float process, updraw and slot draw methods. Additionally, the flexible glass may contain anti-microbial properties by using a chemical composition for the glass including an Ag ion concentration on the surface in the range greater than 0 to 0.047 μg/cm², further described in U.S. Patent Application Publication No. 2012/0034435 A1. The flexible glass may also be coated with a glaze composed of silver, or otherwise doped with silver ions, to gain the desired anti-microbial properties, further described in U.S. Patent Application Publication No. 2011/0081542 A1. Additionally, the flexible glass may have a molar composition of 50% SiO₂, 25% CaO, and 25% Na₂O to achieve the desired anti-microbial effects.

The flexible glass is strengthened due to a compressive stress that is introduced to the flexible glass by sintering the frit material to the flexible glass. The frit material is sintered by heating the frit material, which may be in a powder, solution, or tape form, to a temperature below the specific melting point of the flexible glass, causing atoms in the frit material to diffuse across boundaries of the frit material particles, consolidating the frit material and creating a single solid sintered frit material layer. The sintered frit material layer may have nearly uniform porosity and may create a bond between two materials of different material classes.

Referring first to FIGS. 1 and 2, layered glass structure 10 is generally referred to as a symmetric layered glass structure and includes flexible glass sheets 12 forming a first flexible glass layer 18 and a second flexible glass layer 22, as well as a glass frit material 14 forming a sintered glass frit material layer 20 that is sandwiched between and bonded to the flexible glass sheets 12 of the first and second flexible glass layers 18, 22. A compressive stress is generated across a thickness of the flexible glass sheets 12 in the first and second flexible glass layers 18, 22 due to a mismatch, or difference, between the coefficient of thermal expansion (CTE) of the flexible glass sheet 12 and the CTE of the glass frit material 14. The strengthening compressive stress may enhance the strength or impact resistance of the flexible glass. The CTE of the glass frit material 14 may be adjusted by varying the composition of the glass frit material 14. The sintered glass frit material layer 20 may also have a graded composition and be graded transversely or vertically, allowing the compressive stresses in the flexible glass sheet 12 to be distributed accordingly, as discussed below. Additionally, the compressive stress generated in the flexible glass sheets 12 may be affected by the temperature at which the layered glass structure 10 is heated to sinter the frit material layer 20, as is also discussed herein.

The layered glass structure 10 may have a total thickness 30 of between about 50 μm and about 300 μm. In FIGS. 1 and 2, the total thickness 30 of the layered glass structure 10 may be about 300 μm. As one example, the layered glass structure 10 includes the first flexible glass layer 18 that may have a thickness 24 of about 100 μm, the sintered glass frit material layer 20 may have a thickness 26 of about 100 μm, and the second flexible glass layer 22 may have a thickness 28 of about 100 μm. The flexible glass sheets 12 may be provided in discrete sheet form or may otherwise be provided in a continuous spool. In a specific embodiment of the layered glass structure 10, two 50 μm thick flexible glass sheets 12 with a 100 μm thick layer of frit tape (described below) sandwiched between the glass sheets, have a calculated compressive stress of over 100 MPa across the thicknesses of both glass sheets. In this case, the flexible glass sheet has a CTE of 3 ppm/C, the frit material has a CTE of 10.4 ppm/C and the assembly temperature is greater than about 450 C.

In FIG. 3, the asymmetric layered glass structure 40 includes a first flexible glass layer 42 composed of flexible glass sheet 12, a substrate layer 46 composed of a non-glass substrate material 66, and a sintered glass frit material layer 44 composed of glass frit material 14 sandwiched between the first flexible glass layer 42 and the substrate layer 46. The layered glass structure 40 may have a total thickness 62 of about 300 μm, as one example. The substrate layer 46 may have a thickness 60 equal to about 100 μm. In other embodiments, the thickness 60 of the substrate layer 46 may be less than or equal to 300 μm, such as about 200 μm, about 75 μm, about 50 μm, about 25 μm, or about 10 μm. The substrate material 66 may be a non-glass substrate such as metal, metal alloys such as stainless steel, copper, nickel, brass, bronze, titanium, tungsten, cast iron, aluminum, ceramic, composite, or another rigid material or combinations of these materials, or may also be an alternative glass, such as a glass having an alternate chemical composition, or a different thickness than the first flexible glass layer 42. The compressive stresses generated during forming the layered glass structure 40 may be increased when the first flexible glass layer 42 is sintered to a metal substrate material 66 due to the high CTE of metal. For example, copper has a CTE of 16 ppm/C and a Young's modulus of 115 GPa, and stainless steel has a CTE of 15 ppm/C and Young's modulus of 200 GPa. In a specific embodiment of this layered glass structure 40, the asymmetric layered glass structure 40 may be formed of a flexible glass layer having a thickness of 50 μm sintered to a stainless steel substrate material 66 having a thickness of 200 μm, separated by a sintered glass frit material layer 44 composed of a glass frit material 14 that is frit tape having a thickness of 25 μm. The compressive stress in the flexible glass layer is calculated to be greater than 180 MPa. In this case, the flexible glass sheet has a CTE of 3 ppm/C, the frit material has a CTE of 10.4 ppm/C and the assembly temperature is greater than about 450 C.

The layered glass structures 10 and 40, as well as other layered glass structures described herein, may be formed according to different methods. For example, one method of forming the layered glass structure 10 includes assembling the first and second flexible glass layers 18, 22 with flexible glass sheets 12 and placing the glass frit material 14 in between the flexible glass sheets 12. The entire layered glass structure 10 is then heated in a single thermal cycle, sintering the glass frit material 14 to the flexible glass sheets 12, thereby forming the strengthened layered glass structure 10 and generating the compressive stresses across the flexible glass sheets 12. The thermal cycle may be at a sintering temperature such that the glass frit material 14 is consolidated and adheres to the flexible glass sheet 12. For asymmetric layered glass structures, such as layered glass structure 40, the glass frit material 14 may be positioned on a surface of either the substrate material 66 or the flexible glass sheet 12 prior to heating in a single thermal cycle.

Another method of forming the layered glass structures 10 and 40 includes two thermal cycles. For layered glass structure 10, the glass frit material 14 is positioned on a surface of the flexible glass sheet 12 forming a lower flexible glass layer 34 in FIG. 1. The structure is then heated for one thermal cycle at a temperature lower than the specific sintering temperature of the glass frit material 14. This may cause a binder or any other substance that may be a part of the glass frit material to dissipate or burn off. The second flexible glass sheet 12 that forms an upper flexible glass layer 32 is positioned on top of the structure having gone through the one thermal cycle, and the entire assembly is subjected to a second thermal cycle at a sintering temperature, such as 400 C, that consolidates the glass frit material 14, thereby creating a bond between the glass frit material 14 and the flexible glass sheets 12 and generating compressive stresses across the flexible glass sheets 12. For asymmetric layered glass structure 40, the glass frit material 14 may be positioned on a surface of either the substrate material 66 or the flexible glass sheet 12 before the first thermal cycle, with the remaining layer positioned on top of the pre-sintered structure and subjected to a second thermal cycle at a sintering temperature, according to the materials used in the layered glass structure 40.

Referring again to FIG. 2, the residual compressive stresses in the flexible glass sheets 12 of the first and second flexible glass layers 18, 22 of layered glass structure 10 may be substantially uniform across the thicknesses of the flexible glass layers 18, 22. The residual compressive stresses are generated when the glass frit material 14 is sintered to the flexible glass layers 18, 22 at an elevated sintering temperature and then cooled to room temperature at a cooling rate, such as about 20 C per minute or less, such as about 10 C per minute or less, such as about 5 C per minute or less. The elevated sintering temperature is greater than room temperature and less than a deformation temperature specific to the flexible glass sheets 12, including but not limited to about 400 C or more, such as about 500 C or more, such as about 600 C or more. In the asymmetric layered glass structure 40 of FIG. 3, a thermal mass or deformation temperature of the substrate material 66 may also be considered. Further, while a tri-layer layered glass structure is illustrated in FIGS. 1, 2, and 3, the number of layers can be greater or less than three layers and selected depending on, for example, the end use and processing requirements. Additionally, the layered glass structures described herein may be curved or otherwise shaped so as to have a non-planar contour. Various other layered laminate examples will be described herein.

Referring again to FIGS. 1, 2, and 3, the sintered glass frit material layers 20 and 44 are formed by the glass frit material 14. The glass frit material 14 is a material that is consolidated during a heated thermal cycle, or sintering. The material composition of the glass frit material 14 may affect the CTE of the glass frit material 14, thereby affecting the compressive stresses generated in the flexible glass sheet 12. The material composition of the glass frit material 14 may also be varied according to the strength requirements of the intended application. For example, the glass frit material 14 may be selected such that the glass frit material 14 has a CTE value higher than the CTE value of the flexible glass sheet 12. For example, the glass frit material 14 may have a CTE value about 2 times greater, or about 5 times greater, than the CTE value of the flexible glass sheet 12. In some embodiments, the CTE mismatch may be at least about 3 ppm/° C. or more, such as about 6 ppm/° C.

The sintered glass frit material layer 20 of layered glass structure 10 may be used to bond the first and second flexible glass layers 18, 22 together at interfaces between their respective broad surfaces 36, 38. For layered glass structure 40, the sintered glass frit material layer 44 may be used to bond the first flexible glass layer 42 to the substrate layer 46 at interfaces between their respective broad surfaces 52, 54. In either of the layered glass structures 10, 40, the sintered glass frit material layer 20, 44 may be thin, having a thickness less than or equal to about 200 μm, such as less than or equal to about 100 μm, including less than or equal to about 50 μm, less than or equal to about 25 μm. The glass frit material 14 may be allowed to thermally expand, at least to some degree, relative to the flexible glass sheet or sheets 12 due to the large CTE mismatch between the flexible glass sheet or sheets 12 and the glass frit material 14.

In either of the layered glass structures 10, 40, the glass frit material 14 may be applied such that it covers the entire surface of the flexible glass sheet or sheets 12 or so that it covers less than an entire surface of the flexible glass sheet or sheets 12 for example it may be disposed in a pattern such as a stripe pattern, a zigzag pattern, a random pattern, or the like. This may assist in providing cut lanes or other areas on the layered glass structures 10, 40 that may allow separation of a large layered glass structure into two or more separate layered glass structures. The glass frit material 14 may also be coated onto the substrate using a coating process such as slot die coating, screen printing, or the like.

As discussed above, the glass frit material 14 may be used to bind different classes of materials together, such as a flexible glass and a substrate material. Glass frit may be a frit tape or a frit paste composed of a frit solution with glass frit material and an organic binder. Some or all of the organic binder may be dissipated during heating, allowing the frit to bond to the flexible glass sheet 12 and/or substrate material 66. When a frit is used as the glass frit material 14, the frit may be spread across a surface of the flexible glass sheet 12 rather than just being applied locally. This may reduce the possibility that excessive stresses localized in the frit material may cause debonding or cracking of a layered glass structure.

When the glass frit material 14 is a frit tape, the frit tape may be an unsintered or partially sintered tape that is applied to a surface of the flexible glass or the substrate. In instances where the flexible glass sheet 12 is provided in a continuous spool form, a frit tape may allow for continuous formation of layered glass structures. Additionally, when the flexible glass sheet 12 is provided in continuous spool form and frit is used as the sintered material, the frit may be dispensed in a slot die or tape casting process, for example. Dispensing the frit may provide the ability to start and stop the coating to form cutting lanes or areas without a sintered glass frit material layer.

An example of frit tape that may be used as the glass frit material 14 in the layered glass structures 10, 40 is commercially available from Vitta Corporation, headquartered in Bethel, Conn. Frit tapes are available with materials having CTE values ranging from greater than or equal to 3 ppm/C and less than or equal to 10 ppm/C, and thicknesses ranging from greater than or equal to 25 μm and less than or equal to 125 μm. Specific examples of frit tapes may have a working temperature of 410° Celsius (C) and a CTE value of 7.5 ppm/C; a working temperature of 460 C and a CTE value of 10.4 ppm/C; and a working temperature of 450 C and a CTE value of 8.9 ppm/C.

The glass frit material 14 may include different absorption capabilities to enable different energy sources used during the sintering process. In addition to the glass frit material 14, sintered glass frit material layers may include additional elements, such as scattering elements that enhance applications such as Organic Light Emitting Diode (OLED) lighting and photovoltaic (PV), or ultraviolet light absorbing properties that may enhance the longevity of OLED and PV devices. Scattering elements included in the sintered material may enhance out-coupling or in-coupling for OLED and PV applications. The sintered glass frit material layers may also be formed of, or contain elements that, absorb light at varying wavelengths to enable difference energy sources to be used during sintering.

After heating at a sintering temperature, and being allowed to cool, the layers of flexible glass on the outer surfaces of the layered glass structures 10, 40 develop a compressive stress across the thickness of the flexible glass sheets 12. In symmetric layered glass structure 10, the compressive stresses may be nearly uniform across the flexible glass layers, and in asymmetric layered glass structure 40, the compressive stresses may not be uniform across the flexible glass layer.

Layered Glass Structures with Graded Sintered Material Compositions

Referring now to FIGS. 4-7, the sintered glass frit material layers of the above-described layered glass structures may be formed of a frit tape or a printing process. In these instances, the sintered glass frit material layers may be structured such that the sintered glass frit material layers have a graded composition in a vertical or lateral direction. The sintered material may be graded either across a thickness of the sintered glass frit material layer, or vertically, and/or across a surface, or laterally, of the flexible glass or substrate. A graded composition may assist in placing the resulting compressive and tensile stresses in a specific location within the layered glass structure. The stress profile of the layered glass structure may be modified by grading the composition of the sintered glass frit material layer. For example, a graded composition through the thickness of the sintered glass frit material layer may allow for more control of the established compressive stress profile, while a graded composition across a surface of the substrate or flexible glass may assist in cutting processes or otherwise during separation of the layered glass structure.

In FIG. 4, a layered glass structure 70 includes a sintered glass frit material layer 74 sandwiched between a first flexible glass layer 72 and a second flexible glass layer 76 composed of the flexible glass sheets 12. The sintered glass frit material layer 74 is composed of a frit tape 82 with a vertically graded multi-component composition. The frit tape 82 is graded such that a greater concentration of one component of the frit material that forms the frit tape 82 is at the center of the layered glass structure 70 and a greater concentration of another component of the frit material is at the surfaces. This graded composition may affect the stress profile of the compressive stresses generated in the first and second flexible glass layers 72, 76 of the layered glass structure 70. For example, the compressive stresses may be increased at interfaces 78 and 80 between the frit tape 82 and the first and second flexible glass layers 72, 76, respectively, and decreased at outer surfaces 94, 96 of the layered glass structure 70. A thickness 88 of the frit tape 82 may also be adjusted to form various vertically graded compositions of the frit tape 82, while a total thickness 92 of the layered glass structure 70 may still be less than or about 300 μm.

Referring to FIG. 5, another embodiment of a layered glass structure 100 with a different vertically graded composition frit layer 104 is illustrated. The graded composition frit layer 104 is formed of a graded composition frit tape 112 having a thickness 124, where a higher concentration of one component of the frit material is located near a lower surface 120 of the layered glass structure 100 and a higher concentration of another component of the frit material is located near the upper surface. For example, a flexible glass layer 106 located at the lower surface 120 of the layered glass structure 100, near the frit having a higher concentration of one component, may have a higher compressive stress across its thickness than a flexible glass layer 102 located at an upper surface 118 of the layered glass structure 100. Additionally, the bond formed between the frit tape 112 and a lower flexible glass sheet 116 may be enhanced when one component of the frit material is concentrated closer to one flexible glass sheet in the layered glass structure 100. For example, the bond between the frit material of the frit tape 112 may be stronger at an interface 110 between the frit material of the frit tape 112 and the lower flexible glass sheet 116 than between the bond formed an interface 108 between the frit material of the frit tape 112 and the upper flexible glass sheet 12 of the layered glass structure 100. While the flexible glass layers 102, 106 may both be composed of flexible glass sheets, the flexible glass layers 102, 106 may not be identical. For example, the flexible glass sheet 12 may have a thickness 24 of about 100 μm, while the lower flexible glass sheet 116 may have a thickness 126 greater than or less than about 100 μm, or not identical to the flexible glass sheet 12. A total thickness 128 of the layered glass structure 100, however, may still be less than or about 300 μm.

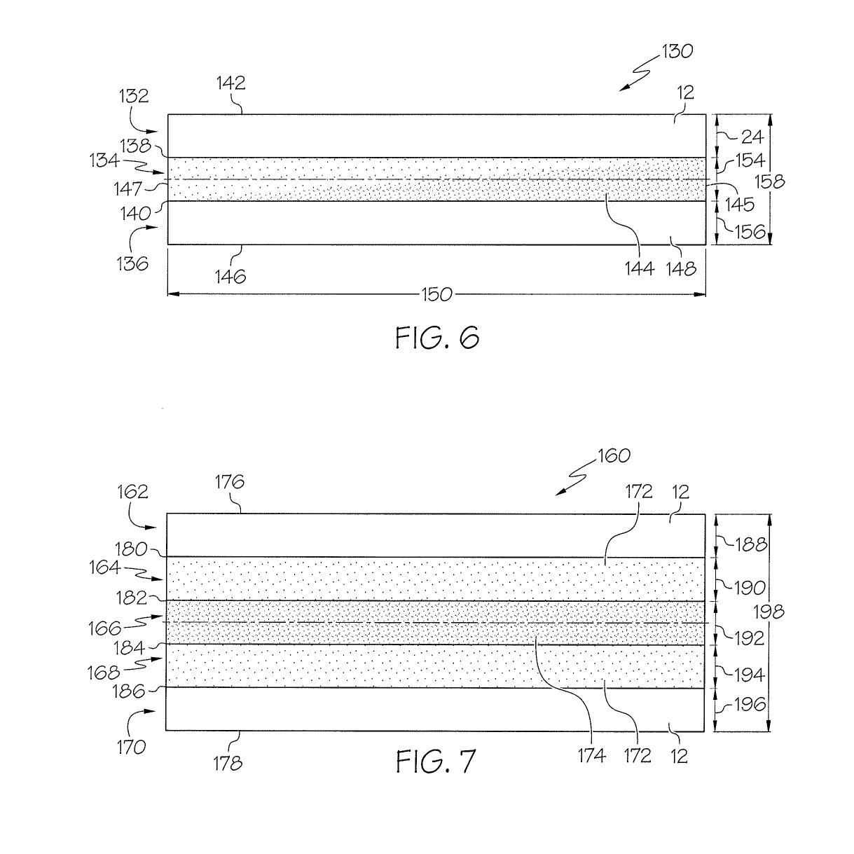

Referring now to FIG. 6, another embodiment of a layered glass structure 130 having a total thickness 158 is shown with a frit layer 134 having a laterally graded composition. The layered glass structure 130 may be asymmetric or symmetric. In this embodiment, the layered glass structure 130 is formed of a flexible glass layer 132 comprised of the flexible glass sheet 12, the frit layer 134 comprised of a frit tape 144, and a substrate layer 136 comprised of a substrate material 148. The substrate material 148 may be any substrate, as discussed above, and may have a CTE that is greater than the CTE of both the frit tape 144 and the flexible glass sheet 12, creating higher compressive stresses than possible with symmetric layered glass structures. The substrate material 148 has a thickness 156 that may be greater than or equal to about 100 μm, and less than or equal to about 5 mm. The frit tape 144 is graded in composition along a width 150 of the layered glass structure 130 and a thickness 154 of the frit tape 144, such that a higher concentration of one component of the frit material is located on a first end 145 of the layered glass structure 130 than on an opposite second end 147 of the layered glass structure 130. A higher concentration of the one component of the frit material is also positioned at an interface 140 between the substrate material 148 and the frit tape 144. A lower concentration of frit material is positioned near an interface 138 between the flexible glass sheet 12 and the frit tape 144. A graded composition of frit material in this manner may create a higher compressive stress along interface 138 of the flexible glass sheet 12 nearer the first end 145 of the layered glass structure 130 than the compressive stress formed across the flexible glass sheet 12 nearer the second end 147 of the layered glass structure 130.

In FIG. 7, a layered glass structure 160 may include more than three layers and may be symmetric or asymmetric. The layered glass structure 160 includes a first flexible glass layer 162 formed of a first flexible glass sheet 12, as well as a second flexible glass layer 170 formed of a second flexible glass sheet 12. Sandwiched between the first and second flexible glass layers 162, 170, are three sintered glass frit material layers. A first sintered glass frit material layer 164 may be identical to a second sintered glass frit material layer 168. The first and second sintered glass frit material layers 164, 168 may be formed of a glass frit material 172, such as a frit tape. The layered glass structure 160 may also include a central sintered glass frit material layer 166 that is also composed of a glass frit material, or frit tape, 174. Any of the sintered glass frit material layers 164, 166, 168 may have a graded composition and may be the identical to or different from any of the other sintered glass frit material layers 164, 166, 168. In this embodiment, the frit tape 174 forming the central sintered glass frit material layer 166 may have a graded composition, or may have a higher concentration of frit material than the first and second sintered glass frit material layers 164, 168. This may affect the stress profile of the layered glass structure 160 such that the compressive stresses developed in the first and second flexible glass layers 162, 170 are focused along certain surfaces or localized to certain regions within the layered glass structure 160. Other embodiments of the layered glass structure 160 may have more or fewer sintered glass frit material layers 164, 166, 168, such as two sintered glass frit material layers, four sintered glass frit material layers, five sintered glass frit material layers, or more. Additionally, some or all of the sintered glass frit material layers may have graded compositions and may be placed in any possible order within the layered glass structure 160.

In any of the embodiments of layered glass structures described herein, further compressive stresses may be generated in the flexible glass sheets by subjecting the layered glass structure to an ion exchange process. Ion exchange processes are chemical strengthening processes that cause compressive stresses within flexible glass sheets to be focused on the outer surface of the flexible glass sheet. For example, ion exchange processes to the layered glass structure 160 of FIG. 7 may cause the compressive stresses in the first flexible glass sheet 12 of the first flexible glass layer 162 to be focused on upper surface 176. Likewise, ion exchange processes may also cause compressive stresses within the second flexible glass sheet 12 of the second flexible glass layer 170 to be focused on lower surface 178. Ion exchanging may be implemented prior to forming the layered glass structure, when forming the layered glass structure, or after the layered glass structure is already formed. For example, flexible glass sheets may be ion exchanged prior to forming the layered glass structure to induce a compressive stress in the flexible glass, or the fully formed layered glass structures may be subjected to an ion exchange process to generate compressive stress within the outer layers of the layered glass structure.

Additionally, the layered glass structures described herein may be cut or separated by applying heat to a local area of the substrate near a cut zone. Heat may reduce the local compressive stresses and allow for various cutting methods to be used, such as CO₂ lasers. After cutting, the layered glass structure may be allowed to return to room temperature, and the compressive stresses return, strengthening the layered glass structure. The strengthened layered glass structures described herein may be subjected to higher temperatures than glass structures with polymer adhesives, as the sintered materials have an increased deformation temperature and/or thermal capacity relative to polymer materials.

### General Considerations

Each non-glass substrates may itself be a layered or composite structure made of different types of metal having different Young's moduli, different Poisson's Ratios, and/or layer thicknesses. In this case, one of skill in the art would be able to homogenize the compound layer to find effective values for the overall layer, including an effective thickness, an effective Young's modulus, and an effective Poisson's Ratio that may be used as described herein to beneficially configure a glass-metal laminate. The composites, for example, may be formed of any combinations of the above materials and/or metals, such as stainless steel, nickel, copper, noble metals, metal oxides, etc.

The layered glass structures described herein may be a optically clear formable and/or flexible structure for use as a protective element in an electronic device, wherein the layered glass structure is a composite structure comprising a layer of flexible glass sheet of a thickness from 5 to 300 microns, and a layer of non-glass substrate, such as metal, ranging in thickness from 0.1 mm to 5 mm. In this connection, the formability of the layered glass structure allows it to deviate from full planarity by bending and/or twisting so it can adapt to the shape or form of some other object.

The flexible glass sheet and non-glass substrates can be provided in sheet form according to a batch process. Alternatively, the flexible glass sheet can be provided in sheet form and the non-glass substrate from a continuous roll. As a further possibility, both flexible glass sheet and non-glass substrate are from continuous rolls.

The above-described layered glass structures with a sintered glass frit material layer provide increased strength to the flexible glass, and may also improve performance, impact resistance, lifetime and mechanical durability. In some embodiments, the flexible glass can also act as a moisture barrier and block undesired UV light. Because the layered glass structures described herein are strengthened, post processing of the layered glass structures can be completed at higher temperatures than can be used for unstrengthened glass structures. Accurate and precise cutting processes may also be performed on the layered glass structures by applying heat locally, thereby relieving the compressive stresses in the flexible glass of the layered glass structure. The compressive stresses will return when the layered glass structure cools to room temperature.

For symmetric layered glass structures, nearly constant uniform compressive stress can be provided through the glass thickness in the above-described layered glass structures. For asymmetric layered glass structures, the substrate material may be protected from scratches, fractures, or other damage by the layer of flexible glass in the layered glass structure. The flexible glass on an outer surface of the layered glass structure may be easier to clean than the surface of the substrate material. For example, a refrigerator door made of a layered glass structure with stainless steel layered to flexible glass may be fingerprint-resistant, or a mobile electronic device battery cover made of a layered glass structure with aluminum layered to flexible glass may be scratch-resistant and easy to clean. Additionally, the substrate materials can provide breakage protection and hold the flexible glass together in the event of any breakage. The asymmetric layered glass structures can provide touch and cover glass, which could be used to replace chemically strengthened glass. Curved display glass, such as that discussed above in connection with asymmetric layered glass structure can be provided.

Additional functionality can be incorporated into non-glass substrates in asymmetric layered glass structures. For example, the substrate material can comprise a metal polarizer sheet, a contrast-enhancing filter-laminate, have anti-reflective properties, color filter properties or color conversion properties. Alternatively or additionally, the non-glass substrate can be designed to block undesired ambient light and/or have scattering particles so that wave guiding is reduced and the brightness of the device is increased. Still further, alternatively or additionally, the glass can have anti-microbial functionality. Such additional functionalities could be incorporated in the flexible glass.

Polymer materials are easily scratched, degrade from environmental elements including sunlight exposure and provide poor moisture/oxygen barrier properties. Glass, on the other hand, is scratch resistant, durable and is known for excellent moisture/oxygen barrier properties. However, glass has higher density compared to, for instance, metal, and is a brittle material where strength of glass is dictated by defects and flaws. The above described layered glass structures and methods of making them take advantage of these two classes of materials and combining into one layered structure having improved barrier properties, lightweight and higher mechanical reliability compared to a bare flexible glass stack.

### CONCLUSION

It should be emphasized that the above-described embodiments of the present disclosure, including any embodiments, are merely possible examples of implementations, merely set forth for a clear understanding of various principles of the disclosure. Many variations and modifications may be made to the above-described embodiments of the disclosure without departing substantially from the spirit and various principles of the disclosure. All such modifications and variations are intended to be included herein within the scope of this disclosure and the present disclosure and protected by the following claims.

What is claimed is:

1. A strengthened layered glass structure comprising:
a first substrate layer comprising a flexible glass sheet having a thickness of ≦300 μm;
a second substrate layer; and
a sintered glass frit material layer coupled to a first surface of the first substrate layer and a second surface of the second substrate layer, the sintered glass frit material layer comprising a sintered glass frit coupled to the first and second surfaces providing the flexible glass sheet with a compressive stress of at least about 100 MPa across a thickness of the flexible glass sheet.

2. The strengthened layered glass structure of claim 1, wherein the flexible glass sheet has a thickness of ≦200 μm.

3. The strengthened layered glass structure of claim 1, wherein flexible glass sheet has a thickness of ≦100 μm.

4. The strengthened layered glass structure of claim 1, wherein the second substrate layer comprises metal, glass, or a metal alloy.

5. The strengthened layered glass structure of claim 1, wherein a thickness of the sintered glass frit material layer is from 25 μm to 125 μm.

6. The strengthened layered glass structure of claim 1, wherein the flexible glass sheet is a chemically strengthened glass sheet.

7. The strengthened layered glass structure of claim 1, wherein a total thickness of strengthened layered glass structure is ≦300 μm.

8. The strengthened layered glass structure of claim 1 comprising multiple sintered glass frit material layers.

9. The strengthened layered glass structure of claim 1, wherein the compressive stress is ≧180 MPa across the thickness of the flexible glass sheet.

10. A method of forming strengthened layered glass structures comprising:
providing a first substrate layer comprising a flexible glass sheet having a thickness ≦300 μm;
applying a layer of glass frit material to a surface of the flexible glass sheet, forming a layered glass structure;
heating the glass frit material at a temperature sufficient for sintering the glass frit material such that upon cooling a compressive stress of at least 100 MPa is introduced across a thickness of the flexible glass sheet.

11. The method of claim 10, wherein the glass frit material is a glass frit tape.

12. The method of claim 10 further comprising providing a second substrate layer to the layered glass structure.

13. The method of claim 12, wherein the second substrate layer is comprised of metal, glass or a metal alloy.

14. The method of claim 10, wherein the compressive stress is ≧180 MPa across a thickness of the flexible glass sheet.

15. The method of claim 10, wherein the flexible glass sheet has a thickness of ≦200 μm.

16. The method of claim 10, wherein the glass frit material has a CTE that is ≧2 times a CTE of the flexible glass sheet.

17. The method of claim 10, wherein a CTE value of the glass frit material is from 3 ppm/C to 10 ppm/C.

18. The method of claim 10, wherein a CTE value of the glass frit material is at least 3 ppm/C greater than a CTE value of the flexible glass sheet.

19. The method of claim 10, wherein the glass frit material has a graded material composition.

20. The method of claim 12, wherein the sintered glass frit material layer includes scattering elements or ultraviolet light absorption properties.
